(19) United States
(12) Patent Application Publication
(10) Pub. No.: US 2026/0110915 A1
(43) Pub. Date: Apr. 23, 2026

(54) OPTICAL ELEMENT, OPTICAL SYSTEM, AND DISPLAY APPARATUS

(71) Applicant: CANON KABUSHIKI KAISHA, Tokyo (JP)

(72) Inventor: Hiroto KANO, Tochigi (JP)

(21) Appl. No.: 19/320,100

(22) Filed: Sep. 5, 2025

(30) Foreign Application Priority Data
Oct. 18, 2024 (JP) 2024-182407

(51) Int. Cl. G02B 27/28; G02B 1/00; G02B 27/00; G02B 27/01; G02B 27/10

(52) U.S. Cl. CPC G02B 27/283; G02B 1/002; G02B 27/0093; G02B 27/0172; G02B 27/1006; G02B 2027/0138

(57) ABSTRACT

Optical elements, optical systems, and display apparatuses are provided herein. One or more optical elements may have first power for first light, and second power for second light different from the first light in at least one of a wavelength or a polarization direction. A predetermined inequality is satisfied.

### BACKGROUND

### Field of the Technology

The aspect of the disclosure relates to one or more embodiments of an optical element for an optical system in a display apparatus such as a head mounted display (HMD).

### Description of the Related Art

Some optical systems for HMDs, as disclosed in Japanese Patent Application Laid-Open No. 2020-507123, guide image light from a display element to the observer's eye and guide light from the eye to an image sensor for line-of-sight detection.

### SUMMARY

One or more embodiments of an optical element according to one or more aspects of the disclosure may have first power for first light, and second power for second light different from the first light in at least one of a wavelength or a polarization direction. The following inequality is satisfied:

|ψ2/ψ1|≤0.025

where ψ1 the first power, and ψ2 is the second power. Alternatively, the second power is smaller than the first power. One or more embodiments of an optical system and display apparatuses may include one or more optical elements in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B illustrate an optical element according to this embodiment.

FIG. 2 is an enlarged view of an optical surface of the optical element.

FIG. 3 is a sectional view illustrating a display apparatus according to a first embodiment.

FIG. 4 is a sectional view illustrating a display apparatus according to a second embodiment.

FIG. 5 is a sectional view illustrating a display apparatus according to a third embodiment.

FIG. 6 illustrates a polarization state and an optical path in the third embodiment.

FIG. 7 is a sectional view illustrating a display apparatus according to a fourth embodiment.

FIG. 8 is a sectional view illustrating a display apparatus according to a fifth embodiment.

FIG. 9 is a sectional view illustrating a display apparatus according to a sixth embodiment.

FIG. 10 is a sectional view illustrating a display apparatus according to a seventh embodiment.

FIG. 11 illustrates an HMD including the display optical system according to any one of the first to seventh embodiments.

### DESCRIPTION OF THE EMBODIMENTS

Referring now to the accompanying drawings, a description will be given of embodiments according to the disclosure.

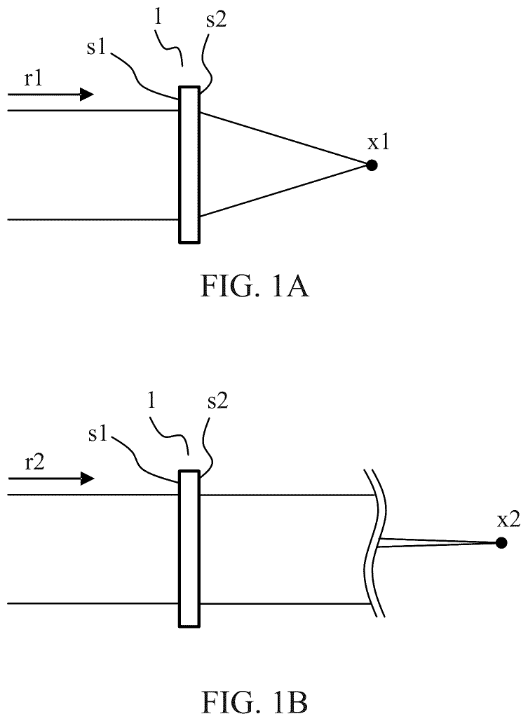

FIGS. 1A and 1B illustrate an optical element 1 according to this embodiment. FIG. 1A illustrates that first light r1 enters the optical element 1, and FIG. 1B illustrates that second light r2 enters the optical element 1. The first light r1 and the second light r2 are different from each other in at least one of the wavelength and polarization direction. Different wavelengths here may mean different wavelengths as single wavelengths (e.g., 800 nm and 550 nm) or different wavelength ranges (e.g., near-infrared range 750-1000 nm and visible range 400-700 nm). Different polarization directions means that the polarization directions are orthogonal to each other or opposite to each other.

The optical element 1 has a first surface s1 and a second surface s2 as optical surfaces. In FIG. 1A, the first light r1 incident on the optical element 1 from the first surface s1 is focused at a focal position x1 by the focusing action of at least one of the first surface s1 and the second surface s2. On the other hand, in FIG. 1B, the second light r2 incident on the optical element 1 from the first surface s1 is focused at a focal position x2 different from the focal position x1 (farther from the optical element 1) due to the focusing action of at least one of the first surface s1 and the second surface s2.

In FIGS. 1A and 1B, the optical element 1 has positive power, but it may have negative power. In FIG. 1B, the optical element 1 may not have power with respect to the second light r2. In FIGS. 1A and 1B, the optical element 1 transmits the first light r1 and the second light r2, but the optical element 1 may reflect the first light r1 and the second light r2.

At least one of the first surface s1 and the second surface s2 is not limited to a flat surface, and may be a curved surface (spherical surface, uncurved surface) or a diffraction surface, or may be a metasurface.

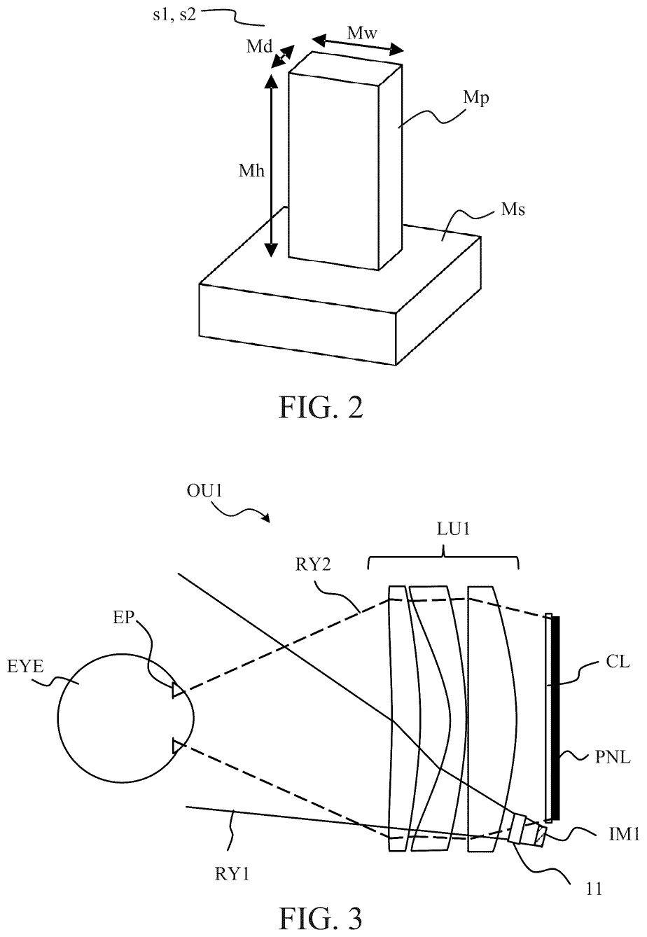

FIG. 2 illustrates an example of the configuration of a metasurface. The metasurface is constructed by arranging nanopillars Mp, which are structures sufficiently smaller than the wavelength of light, two-dimensionally on a substrate Ms. FIG. 2 illustrates a single nanopillar Mp. The metasurface forms a phase difference between the first light r1 and the second light r2 according to the height Mh, depth Md, width Mw, material, direction, and pitch of the nanopillar Mp. Thereby, the action on the first light r1 and the second light r2 can be controlled.

For example, in Optics Letters, Vol. 46, 6, 1193 (2021), Xiang et al., report a metasurface that focuses light whose polarization directions are orthogonal to each other in a wide wavelength range at different focal points. U.S. Patent Publication No. 11977950 discloses a metalens that changes the optical path in different wavelength ranges.

FIG. 2 illustrates that the nanopillar Mp has a rectangular parallelepiped shape, but the shape of the nanopillar may be changed according to the wavelength range and polarization state. The nanopillar may be covered with air or another medium.

The optical element 1 may be configured by bonding a plurality of elements together, or may be configured by laminating a plurality of films.

### First Embodiment

FIG. 3 illustrates the configuration of a display apparatus OU1 according to a first embodiment. The display optical system LU1 according to this embodiment allows observation of an enlarged image (display image) of an original image by guiding image light from a display surface PNL on which the original image is displayed to a pupil EP of an observer's eye EYE. The display surface PNL is a modulation surface of a display element (light modulation element) such as a Liquid Crystal Display (LCD) or Organic Light Emitting Diode (OLED) display. Between the display optical system LU1 and the display surface PNL, a cover glass CL is disposed as a parallel plate having no refractive power. The display optical system LU1 and the display surface PNL constitute a display system.

The display apparatus OU1 captures a corneal image by capturing imaging light (light reflected by the cornea) from the cornea of the eye EYE on an imaging surface IM through the display optical system LU1 and a first optical element 11. The first optical element 11 has a function of the optical element 1 described with reference to FIGS. 1A and 1B. The first optical element 11 and the imaging surface IM are disposed on the display surface side of the display optical system LU1. The imaging surface IM is a light receiving surface of an image sensor such as a Charge Coupled Device (CCD) sensor, a Complementary Metal Oxide Semiconductor (CMOS), or a Single Photon Avalanche Diode (SPAD) sensor. The display optical system LU1 and the first optical element 11 constitute an imaging optical system, and the imaging optical system and the image sensor constitute an line-of-sight detection camera as an imaging system.

In this embodiment, the first light reaching the imaging surface IMI from the eye EYE is defined as imaging light RY1, and the second light reaching the pupil EP from the display surface PNL is defined as image light RY2.

At least a part of the area of the first optical element 11 having power is disposed in the optical path of the image light RY2. That is, a part of the image light RY2 passes through the area of the first optical element 11 having power. This configuration can reduce a tilt angle of the optical axis of the line-of-sight detection camera relative to the cornea of the eye EYE, and reduce shielding of the imaging light RY1 due to the direction of the eye EYE and the thickness of the observer's eyelids, etc. As a result, the line-of-sight detection accuracy can be improved.

The image light RY2 is light with a wavelength in the visible range that allows the observer to view the display image, and the imaging light RY1 is light with a wavelength in the near-infrared range that is outside the visible range for line-of-sight detection. The image sensor having the imaging surface IM has sensitivity in the near-infrared range.

In this embodiment, in order for the observer to view a good display image, the power of the first optical element 11 for the image light RY2 is smaller than the power of the first optical element 11 for the imaging light RY1 (conversely, the power of the first optical element 11 for the imaging light RY1 is greater than the power of the first optical element 11 for the image light RY2). In order to have different powers according to wavelengths, the first optical element 11 may use a metasurface.

Since at least a part of the image light RY2 passes through the first optical element 11, i.e., at least a part of the first optical element 11 is disposed in the optical path of the image light RY2, the size of the display apparatus OU1 can be reduced compared to a case where the first optical element 11 is disposed outside the optical path of the image light RY2.

This embodiment enables the observer to view a good display image with little distortion while achieving high line-of-sight detection accuracy despite its small size.

In this embodiment, the display optical system LU1 includes three lenses, but the number of lenses may be increased to correct a variety of aberrations, or may be reduced to reduce the size.

As illustrated in FIG. 3, a part of the imaging light RY1 passes through the periphery of the display optical system LU1 and enters the imaging surface IM. In this case, in order to correct decentering aberration caused by the display optical system LU1, the first optical element 11 may include an asymmetric (non-rotationally symmetric) optical surface.

The imaging surface IM may be disposed parallel to or on the same plane as the display surface PNL. This configuration allows the imaging surface IM and the display surface PNL to be arranged closely together on the same element (or the same substrate), and thereby the size of the entire display apparatus OU1 can be reduced.

A description will now be given of a relationship between the powers of the first optical element 11 (optical element 1) for the imaging light RY1 and the image light RY2. The following inequality may be satisfied:

$$\vert ψ2 / ψ1 \vert \leq 0. 025 \qquad ( 1 )$$

where ψ1 is the power (first power) of the first optical element 11 for the imaging light RY1, and ψ2 is the power (second power) of the first optical element 11 for the image light RY2.

Since power is a reciprocal of a focal length (ω1=1/f1, ψ2=1/f2), inequality (1) can be rewritten as follows:

$$\vert f 1 / f 2 \vert \leq 0. 025 \qquad ( 2 )$$

where f1 is a focal length of the first optical element 11 for the imaging light RY1, and f2 is a focal length of the first optical element 11 for the image light RY2.

In a case where inequality (1) or (2) is satisfied so that the power of the first optical element 11 for the image light RY2 is smaller than the power of the first optical element 11 for the imaging light RY1, the observer can view a good display image with little distortion.

In a case where the first optical element 11 has no power for the image light RY2, ψ2 is set to 0, f2 to infinity, and |ψ2/ψ1|=0.000, |f1/f2|=0.000. The upper limits of inequalities (1) and (2) may be set to 0.020, 0.015, or 0.010. Inequalities (1) and (2) may be satisfied also in other embodiments described later.

### Second Embodiment

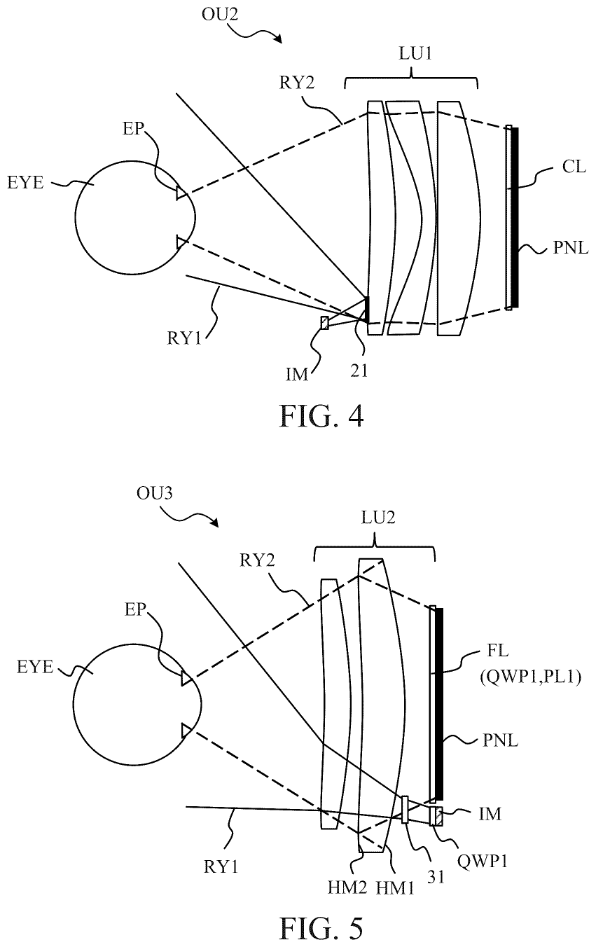

FIG. 4 illustrates the configuration of a display apparatus OU2 according to a second embodiment. The display apparatus OU2 uses the same display optical system LU1 as that of the first embodiment, but uses a first optical element 21 that is different from the first optical element 11 according to the first embodiment.

The first optical element 21 is provided on the lens surface closest to the observation side (eye side) of three lenses that constitute the display optical system LU2. The imaging light from the cornea of the eye EYE is reflected by the first optical element 21 and guided to the imaging surface IM. That is, the first optical element 21 and the imaging surface IM are disposed on the observation side of the display optical system LU1.

In this embodiment, at least a part of the area of the first optical element 21 having power is disposed in the optical path of the image light RY2. This configuration can reduce a tilt angle of the optical axis of the line-of-sight detection camera relative to the observer's cornea. The power of the first optical element 21 for the image light RY2 is smaller than the power of the first optical element 21 for the imaging light RY1. The first optical element 21 may use a metasurface.

This embodiment enables the observer to visually recognize a good display image with little distortion while achieving high line-of-sight detection accuracy and a reduced size.

### Third Embodiment

FIG. 5 illustrates the configuration of a display apparatus OU3 according to a third embodiment. The display apparatus OU3 includes a display optical system LU2 including two lenses and a first optical element 31 included in the imaging optical system. The display optical system LU2 includes a polarizing unit FL disposed on the observation side of the display surface PNL. The polarizing unit FL includes a polarizing plate and a quarter waveplate as described later.

A first optical element 31 and an imaging surface IM are disposed closer to the display surface side than the display optical system LU2. In this embodiment, at least a part of the area of the first optical element 31 having power is disposed in the optical path of the image light RY2. The power of the first optical element 31 for the image light RY2 is smaller than the power of the first optical element 31 for the image pickup light RY1.

The display optical system LU2 includes a first transmissive reflective surface HM1 and a second transmissive reflective surface HM2. In this embodiment, the first transmissive reflective surface HM1 is provided on the lens surface of the lens on the display surface side of the two lenses, and the second transmissive reflective surface HM2 is provided on the lens surface on the observation side of the same lens. However, at least one of the first and second transmissive reflective surfaces HM1 and HM2 may be provided on the lens on the observation side. The ratio of the transmittance and reflectance of each of the first and second transmissive reflective surfaces HM1 and HM2 may be 50:50 or may be any other ratio.

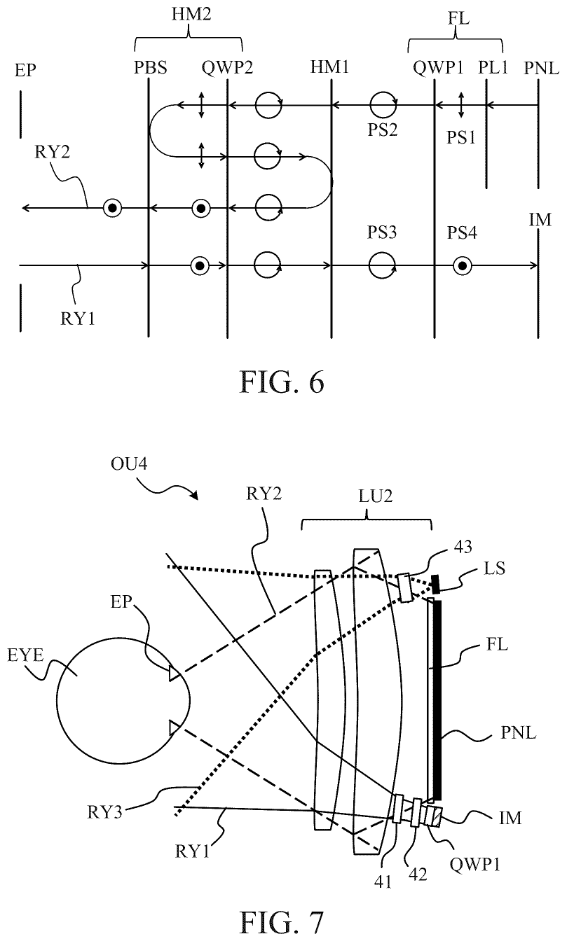

FIG. 6 illustrates the polarization state and the optical path in the display apparatus OU3. The polarizing unit FL includes a first polarizing plate PL1 and a first quarter waveplate QWP1. The first polarizing plate PL1 transmits linearly polarized light with a polarization direction parallel to its transmission axis and absorbs linearly polarized light with a polarization direction perpendicular to the transmission axis. In a case where the display surface PNL can control the polarization state by the orientation of the liquid crystal like an LCD, the polarizing unit FL may be omitted. A first quarter waveplate QWP1 is also disposed between the first optical element 31 and the imaging surface IM. This first quarter waveplate QWP1 may be integrated with the first quarter waveplate QWP1 of the polarizing unit FL.

The second transmissive reflective surface HM2 includes a second quarter waveplate QWP2 and a polarization separation element PBS having polarization selectivity. The polarization separation element PBS transmits linearly polarized light with a polarization direction parallel to its transmission axis and reflects linearly polarized light with a polarization direction perpendicular to the transmission axis. The second quarter waveplate QWP2 and the polarization separation element PBS may be provided on different lens surfaces, not on the same lens surface.

The linearly polarized light of the image light RY2 as unpolarized light that has transmitted through the first polarizing plate PL1 of the polarizing unit FL is converted into clockwise circularly polarized light by the first quarter waveplate QWP1. A part of the clockwise circularly polarized light that has transmitted through the first transmissive reflective surface HM1 is converted into linearly polarized light (S-polarized light) by the second quarter waveplate QWP2, and this linearly polarized light is reflected by the polarization separation element PBS. A part of the clockwise circularly polarized light that is reflected by the first transmissive reflective surface HM1 becomes counterclockwise circularly polarized light, which is converted by the first quarter waveplate QWP1 into linearly polarized light with a polarization direction perpendicular to the transmission axis of the first polarizing plate PL1, and this linearly polarized light is absorbed by the first polarizing plate PL1.

The linearly polarized light reflected by the polarization separation element PBS is converted into clockwise circularly polarized light by the second quarter waveplate QWP2, and a part of the clockwise circularly polarized light is reflected by the first transmissive reflective surface HM1 to become counterclockwise circularly polarized light. A part of the clockwise circularly polarized light that has transmitted through the first transmissive reflective surface HM1 is converted by the first quarter waveplate QWP1 into linearly polarized light with a polarization direction perpendicular to the transmission axis of the first polarizer PL1, and the linearly polarized light is absorbed by the first polarizer PL1.

The counterclockwise circularly polarized light reflected by the first transmissive reflective surface HM1 is converted into linearly polarized light (P-polarized light) by the second quarter waveplate QWP2, transmits through the polarization separation element PBS, and reaches the pupil EP of the observer's eye EYE.

Thus, the image light RY2 follows an optical path that reflects twice within the display optical system LU2 and reaches the pupil EP. This configuration can increase a field angle and satisfactorily correct a variety of aberrations while suppressing the thickness of the display optical system LU2 in the optical axis direction.

On the other hand, the imaging light RY1 transmits through the second transmissive reflective surface HM2 and the first transmissive reflective surface HM1 in this order, then transmits through the first optical element 31, and is imaged on the imaging surface IM. By guiding the imaging light RY1 onto the imaging surface IM without reflecting it within the display optical system LU2, the number of times the imaging light RY1 passes through the first and second transmissive reflective surfaces HM1 and HM2 can be reduced, and a decrease in a light amount incident on the imaging surface IM can be suppressed.

In this embodiment, the polarization directions of the polarization state PS1 when the image light RY2 from the display surface PNL transmits through the first polarizing plate PL1 of the polarizing unit FL and the polarization state PS4 when the imaging light RY1 from the pupil EP transmits through the first quarter waveplate QWP1 and travels toward the imaging surface IM are orthogonal to each other. The polarization state PS2 of the image light RY2 that has transmitted through the first quarter waveplate QWP1 and the polarization state PS3 of the imaging light RY1 that has transmitted through the first transmissive reflective surface HM1 and is about to enter the first quarter waveplate QWP1 are circularly polarized in opposite directions. This embodiment uses the first optical element 31 that has a metasurface whose power for the image light RY2 is smaller than that for the imaging light RY1 due to the difference in these polarization states. Thereby, the first optical element 31 can be disposed in the optical path of the image light RY2.

The first optical element 31 may have a metasurface whose powers for the image light RY2 and the imaging light RY1 differ according to a wavelength difference between them. The first optical element 31 may have a metasurface whose powers for the image light RY2 and the imaging light RY1 differ according to the polarization state and wavelength difference between the image light RY2 and the imaging light RY1.

The first and second transmissive reflective surfaces HM1 and HM2 may be provided on the surface of a substrate that is a parallel plate that has no refractive power.

The optical path of the polarization state illustrated in FIG. 6 is merely an example, and the direction of the transmission axis of each of the polarizing plate and the polarization separation element, and the conversion action of the polarization state by the quarter waveplate may be changed. The polarization separation element is not limited to an element that transmits and reflects according to the polarization direction of linearly polarized light, but may be an element that transmits and reflects according to the polarization direction of circularly polarized light. The first transmissive reflective surface may be changed to a surface that transmits and reflects according to the polarization direction.

This embodiment also enables the observer to view a good display image with little distortion while achieving high line-of-sight detection accuracy and a reduced size.

### Fourth Embodiment

FIG. 7 illustrates the configuration of a display apparatus OU4 according to a fourth embodiment. The display apparatus OU4 includes the same display optical system LU2 as that of the third embodiment, and two first optical elements 41 and 42 included in the imaging optical system.

Even in this embodiment, the first optical elements 41 and 42 and the imaging surface IM are disposed on the display surface side of the display optical system LU2. Both of the first optical elements 41 and 42 have the function of the optical element 1 described with reference to FIGS. 1A and 1B. At least a part of the area having power among the first optical elements 41 and 42 is disposed in the optical path of the image light RY2. The combined power of the first optical elements 41 and 42 for the image light RY2 is smaller than the combined power for the imaging light RY1. Thus, the imaging system may include a plurality of first optical elements.

The display apparatus OU4 includes a light source LS such as an LED, that is disposed closer to the display surface than the display optical system LU2 and emits illumination light RY3 as third light in the near-infrared region, and an illumination optical element 43 as a second optical element disposed between the light source LS and the display optical system LU2. The illumination light from the light source LS is irradiated onto the observation side (eye EYE) via the illumination optical element 43 and the display optical system LU2. The illumination system includes the light source LS, the illumination optical element 43, and the display optical system LU2. The illumination optical element 43 also has the function of the optical element 1 described with reference to FIGS. 1A and 1B. At least a part of the region of the illumination optical element 43 that has power for the illumination light is disposed in the optical path of the image light RY2.

This embodiment includes an illumination system for line-of-sight detection, which has a reduced size and enables the observer to view a good display image with little distortion while achieving high line-of-sight detection accuracy.

The light source LS may be disposed on the observation side of the display optical system LU2, and the illumination light RY3 from the light source LS may be reflected by the illumination optical element 43 disposed on the lens surface of the display optical system LU2 closest to the observation plane and irradiated on the observation side.

### Fifth Embodiment

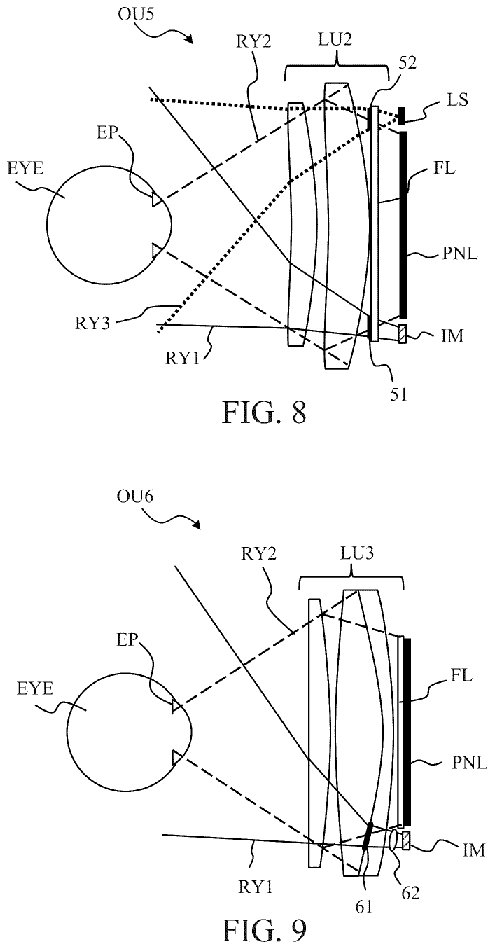

FIG. 8 illustrates the configuration of a display apparatus OU5 according to a fifth embodiment. The display apparatus OU5 includes the same display optical system LU2 as that of the third and fourth embodiments, and a first optical element 51 included in the imaging optical system. In this embodiment, the polarizing unit FL is included in the imaging optical system and the illumination optical system.

Even in this embodiment, the first optical element 51 and the imaging surface IM are disposed on the display surface side of the display optical system LU2. The first optical element 51 has the function of the optical element 1 described with reference to FIGS. 1A and 1B. At least a part of the area of the first optical element 51 having power is disposed in the optical path of the image light RY2. The power of the first optical element 51 for the image light RY2 is smaller than the power of the first optical element 51 for the imaging light RY1. The first optical element 51 is provided on a surface on the observation side of the polarizing unit FL.

The display apparatus OU5 includes a light source LS configured to emit illumination light RY3, and an illumination optical element 52 as a second optical element disposed between the light source LS and the display optical system LU2. The illumination light from the light source LS is irradiated onto the observation side via the illumination optical element 52 and the display optical system LU2. The illumination optical element 52 also has the function of the optical element 1 described with reference to FIGS. 1A and 1B. At least a part of the area of the illumination optical element 52 having power is disposed in the optical path of the image light RY2. The illumination optical element 52 is provided on a surface on the observation side of the polarizing unit FL.

This embodiment also includes an illumination system for line-of-sight detection, which has a reduced size and enables the observer to view a good display image with little distortion while achieving high line-of-sight detection accuracy. In this embodiment, the first optical element 51 and the illumination optical element 52 are integrated with the polarizing unit FL, and can suppress an increase in the number of parts constituting the display apparatus OU5.

### Sixth Embodiment

FIG. 9 illustrates the configuration of a display apparatus OU6 according to a sixth embodiment. The display apparatus OU6 includes a display optical system LU3 including three lenses, and a first optical element 61 and an optical element (lens in the FIG. 62 included in the imaging optical system. The display optical system LU3 includes a polarizing unit FL similar to that of the third embodiment.

The imaging surface IM is disposed closer to the display surface than the display optical system LU3. The first optical element 61 has the function of the optical element 1 described with reference to FIGS. 1A and 1B. At least a part of the area of the first optical element 61 having power is disposed in the optical path of the image light RY2. The power of the first optical element 61 for the image light RY2 is smaller than the power of the first optical element 61 for the imaging light RY1. The first optical element 61 is disposed on a cemented surface of a cemented lens included in the display optical system LU3.

On the other hand, the optical element 62 is disposed outside the optical path of the image light RY2, and does not have the function of the optical element 1 described with reference to FIGS. 1A and 1B. The optical element 62 is not limited to a biconvex lens as illustrated in FIG. 9, but may be a biconcave lens, a meniscus lens, a diffractive element, a mirror, etc. A plurality of optical elements may be provided as the optical element 62.

### Seventh Embodiment

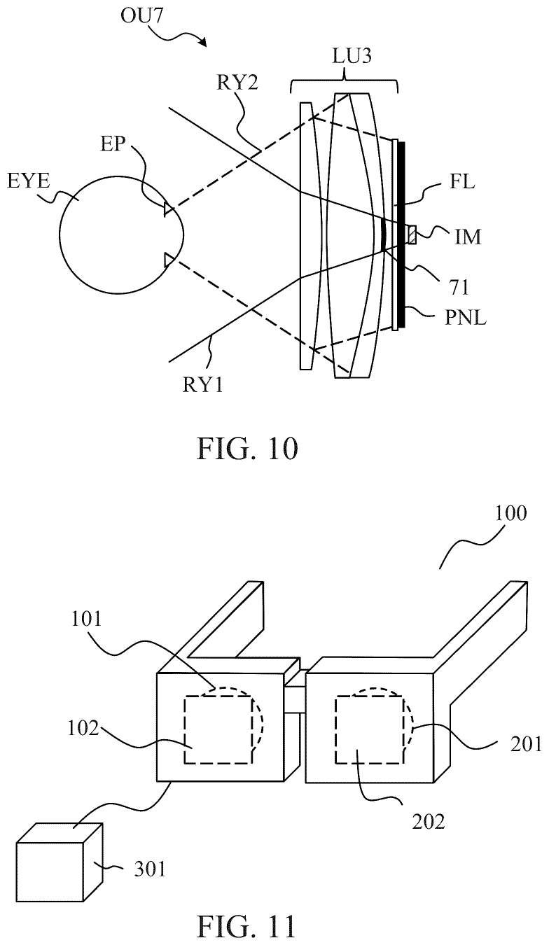

FIG. 10 illustrates the configuration of a display apparatus OU7 according to a seventh embodiment. The display apparatus OU7 includes the same display optical system LU3 as that of the sixth embodiment, and a first optical element 71 included in the imaging optical system.

The imaging surface IM is disposed on the rear side of the display surface PNL (the opposite side of the display surface PNL from the observation side). Such a configuration is also called an under-display camera.

The first optical element 71 has the function of the optical element 1 described with reference to FIGS. 1A and 1B. The entire area of the first optical element 71 having power is disposed in the optical path of the image light RY2. The power of the first optical element 71 for the image light RY2 is smaller than the power for the imaging light RY1. The first optical element 71 is disposed on a lens surface closest to the display surface in the display optical system LU3.

This embodiment improves the degree of freedom in the arrangement of the first optical element 71 and the display surface PNL, and can reduce the thickness of the entire display apparatus OU7 and suppress an increase in the number of parts.

### Head Mounted Display (HMD)

FIG. 11 illustrates an HMD 100 that applies the display apparatus according to the first embodiment to the seventh embodiment. The HMD 100 includes a right optical system 101 and a left optical system 201, and a right display unit 102 and a left display unit 202. Each of the optical systems 101 and 201 includes a display system and an imaging system (and also an illumination system) as described in each embodiment.

Display light from the display surface (original image) in the right and left display units 102 and 202 is guided to the right and left eyes of the observer through the right and left optical systems 101 and 201, respectively. Thereby, the observer can view an enlarged display image. Providing parallax to the original images displayed on the right and left display units 102 and 202 enables the observer to observe a display image that can be viewed stereoscopically. The display units or optical systems may be different for the left and right according to the observer's eyesight, etc.

A calculator 301 is connected to the HMD 100, which detects the lines of sight of the observer's right and left eyes based on corneal images captured by the right and left imaging systems. The resolution of the original image displayed on the display units 102 and 202 can be changed or the displayed user interface (menu image) can be operated according to the lines of sight detected by the calculator 301. The observer may also be authenticated using the iris images of the observer obtained by the imaging systems. An imaging system for acquiring a corneal image or an iris image may be provided on only one eye side.

The display apparatuses according to the first to seventh embodiments may be used as a variety of display apparatuses, such as an electronic viewfinder, which guides light from a display surface to the observer's eye, in addition to an HMD.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure can provide an optical element that has a reduced size and can provide good image display and imaging.

This application claims the benefit of Japanese Patent Application No. 2024-182407, which was filed on Oct. 18, 2024, and which is hereby incorporated by reference herein in its entirety.

What is claimed is:

1. An optical element having first power for first light, and second power for second light different from the first light in at least one of a wavelength or a polarization direction,
wherein the following inequality is satisfied:
$$\vert ψ2 / ψ1 \vert \leq 0. 025$$
where ψ1 the first power, and ψ2 is the second power.

2. The optical element according to claim 1, wherein the optical element transmits or reflects the first light and the second light.

3. The optical element according to claim 1, wherein the second light is light with a wavelength in a visible range, and
wherein the first light is light with a wavelength outside the visible range.

4. The optical element according to claim 1, wherein polarization directions of the first light and the second light are orthogonal to each other or opposite to each other.

5. The optical element according to claim 1, wherein the optical element has a metasurface.

6. An optical element having first power for first light, and second power for second light different from the first light in at least one of a wavelength and a polarization direction,
wherein the second power is smaller than the first power.

7. An optical system comprising:
a first optical element serving as the optical element according to claim 1; and
a display optical system configured to guide the second light from a display surface to an observation side,
wherein the first light from the observation side is guided to an imaging surface via the first optical element.

8. The optical system according to claim 7, wherein at least a part of an area having the first power and the second power in the first optical element is disposed in an optical path of the second light.

9. The optical system according to claim 7, wherein the first light is guided to the imaging surface via the display optical system and the first optical element.

10. The optical system according to claim 7, wherein the display optical system includes two transmissive reflective surfaces configured to transmit and reflect the second light, and
wherein the two transmissive reflective surfaces transmit the first light from the observation side without reflecting the first light, and guide the first light toward the imaging surface.

11. The optical system according to claim 10, wherein one of the two transmissive reflective surfaces includes a polarization separation element configured to transmit and reflect the second light according to a polarization state.

12. The optical system according to claim 7, further comprising a second optical element as the optical element,
wherein third light from a light source is guided to the observation side via the second optical element.

13. The optical system according to claim 12, wherein at least a part of an area having power for the third light in the second optical element is disposed in an optical path of the second light.

14. The optical system according to claim 12, wherein the third light is guided to the observation side via the second optical element and the display optical system.

15. The optical system according to claim 12, wherein the third light reflected on the observation side is guided to the imaging surface as the first light.

16. A display apparatus comprising:
the optical system according to claim 7;
a display element having the display surface; and
an image sensor having the imaging surface.

17. The display apparatus according to claim 16, wherein the image sensor performs imaging for detecting a line of sight of an observer.
